(19) United States
(12) Patent Application Publication
(10) Pub. No.: US 2013/0287919 A1
(43) Pub. Date: Oct. 31, 2013

(54) METHOD OF USING DIETARY INGREDIENTS DIHYDROQUERCETIN (TAXIFOLIN), ARABINOGALACTAN AND ARABINOGALACTAN IN COMBINATION WITH DIHYDROQUERCETIN (TAXIFOLIN) FOR APPLICATIONS IN FOOD PRODUCTS

(71) Applicants: Sergey V. Philippov, Moscow (RU); Igor M. Bogorodov, Moscow (RU)

(72) Inventors: Sergey V. Philippov, Moscow (RU); Igor M. Bogorodov, Moscow (RU)

(73) Assignee: FLAVITPURE, INC., Cheyenne, WY (US)

(21) Appl. No.: 13/456,979

(22) Filed: Apr. 26, 2012

(51) Int. Cl. A23L 3/3454

(52) U.S. Cl. 426/541

(57) ABSTRACT

A method of using a dietary ingredient by combining an effective amount of a dietary ingredient selected from the group consisting of Dihydroquercetin (taxifolin), Arabinogalactan and Arabinogalactan in combination with Dihydroquercetin (taxifolin) with a food such that the dietary ingredient preserves nutritional quality of the food, enhances a shelf life or stability of the food and improves organoleptic properties of the food without changing a nature, substance or quality of the food. The method further includes providing the combination of the dietary ingredient and the food to a group of consumers having special dietary needs. The dietary ingredient is used herein as an antioxidant to prolong the shelf-life of the food by protecting it against deterioration caused by oxidation and preservatives and against deterioration caused by microorganisms, and to aid in manufacturing, processing, preparation, treatment, packing, transporting or storing of the food.

### REFERENCES

[1]. Tatjana Stevanovic, Papa Niokhor Diouf and Martha Estrella Garcia-Perez (2009). Bioactive Polyphenols from Healthy Diets and Forest Biomass. Current Nutrition & Food Science, Vol. 5, No. 4, p. 264-295.

[2] Lee S B, Cha K H, Selenge D, Solongo A, Nho C W (2007). The chemopreventive effect of taxifolin is exerted through ARE-dependent gene regulation. Biol Pharm Bull., 30(6): 1074-1079.

[3] Gupta M B, Bhalla T N, Gupta G P, Mitra C R, Bhargava K P. (1971). Anti-inflammatory activity of taxifolin. Japan J Pharmacol., 21(3):377-82.

[4] Hillis W E (1971) Distribution, properties and formation of some wood extractives. Wood Science and Technology 5: 272-289.

[5] Coté W A, Day A C, Simson B W, Timell T E (1966) Studies on larch arabinogalactan 1. The distribution of arahionogalactan in larch wood. Holzforschun2 20: 178-192.

[6] S. Willfor, R. Sjoholm, C. Laine, B. Holmbom. (2002) Structural features of water-soluble arabinogalactans from Norway spruce and Scots pine heartwood. Wood Science and Technology, 36 : 101-110.

[7] Lewin M. & Goldstein I. S. (1991): Wood structure and composition. Marcel Dekker, Inc. International fiber science and technology series: vol. 11. ISBN: 0-8247-8233-x

[8] Giwa S. A. O. & Swan E. P. (1975). Heartwood extractives of a western larch tree (Larix occidentalis Nutt.). Wood and Fiber vol. 7(3), pp. 216-221.

[9] Terziev, N. (2002b): Properties and Processing of Larch Timber—a Review based on Soviet and Russian Literature.

[10]. Pew, John C., 1947. A flavanone from Douglas-fir heartwood.J. Am. Chem. Soc., 70 (9), pp 3031-3034.

[11]. E. F. Kurth, Harry J. Kiefer, and James K. Hubbard, (1948). Utilization of Douglas-fir Bark The Timberman, Vol. 49, No. 8, pp. 130-1.

[12]. H. M. Graham, E. F. Kurth, (1949). Constituents of Extractives from Douglas Fir. Ind. Eng. Chem., 41 (2), pp 409-414.

[13]. Migita, Nobuhiko,-Nakano, Junzs, Sakai, Isamu, and Ishi, Shoichi, (1952). Japan Tech. Assoc. Pulp Paper Ind. 6:476-480.

[14]. Kurth. E. F., and Chan, F. L., (1953). “Extraction of Tannin and Dihydroquercetin from Douglas Fir Bark.”J. Amer. Leather Chem. Assoc. 48(1):20-32, Abstr. Bull. Inst. Pap. Chem. 23:469.

[15]. G. M. Barton, J. A. F. Gardner. (1958). Determination of Dihydroquercetin in Douglas Fir and Western Larch Wood. Anal. Chem., 30 (2), pp 279-281.

[16]. G. V. Nair and E von Rudloff. (1959). THE CHEMICAL COMPOSITION OF THE HEARTWOOD EXTRACTIVES OF TAMARACK (LARIX LARICENA (DU ROI) K. KOCH)1. Can. J. Chem., Vol. 37, pp. 1608-1613.

[17]. Tyukavkina. N. A., Lapteva, K. I., Larina V. A.,(1967). Extractives of Larix dahurica.Quantitative content of quercetin and dihydroquercetin.Chemistry of Natural Substances. Issue 5, pages 298-301.

[18]. Pietarinen S P, Willfor S M, Vikstrom F A, Holmbom B R. (2006) Aspen knots, a rich source of flavonoids. J Wood Chem Technol., 26: 245-58.

[19]. Conde E, Cadahia E, Garciavallejo M, Tomasbarberan F. (1995) Lowmolecular-weight polyphenols in wood and bark of Eucalyptus globulus. Wood Fiber Sci., 27: 379-83.

[20]. Antonova, G. F. 1980. Zapasi, sostav i svojstva drevesini listvennitzej.In “Issledovaniya v oblasti drevesiny i drevesnykh materialov”.Institut lesa i drevesiny, Krasnoyarsk, 6-18.

[21]. G. V. Nair and E. von Rodloff. (1959). THE CHEMICAL COMPOSITION OF THE HEARTWOOD EXTRACTIVES OF TAMARACK (LARIX LARICINA (DU ROI) K. KOCH).CANADIAN JOURNAL OF CHEMISTRY.VOL. 37.Issued as N.R.C. No. 5295.

[22]. HENRIK OUTTRUP, KJELD SCHAUMBURG and JORGEN OGAARD MADSEN. (1985). ISOLATION OF DIHYDROMYRICETIN AND DIHYDROQUERCETIN FROM BARK OF PINUS CONTORTA. Carlsberg Res. Commun. Vol. 50, p. 369-379.

[23] Davies, M. J., Fu, S. and Dean, R. T. 1995. Protein hydroperoxides can give rise to reactivefree radicals. Biochem. J. 305: 643-649.

[24] Stadtman, E. R. and Levine, R. L. 2003. Free radical-mediated oxidation of free amino acidsand amino acid residues in proteins.Amino Acids. 25: 207-218.

[25] Schaich, K. M. 2008. Co-oxidation of proteins by oxidizing lipids. In: Lipid OxidationPathways. Kamal-Eldin, A.,Min, D. B., Eds., pp 181-272 AOCS Press, Urbana, Ill., Vol. 2.

[26] Karel, M., Schaich, K. and Roy, R. B. 1975. Interaction of peroxidizing methyl linoleate withsome proteins and amino-acids. J. Agric. Food. Chem. 23: 159-163.

[27] Rice-Evans, C. and Burdon, R. 1993. Free-radical lipid interactions and their pathologicalconsequences.Prog. Lipid Res. 32: 71-110.

[28] Levine, R. L. and Stadtman, E. R. 2001. Oxidative modification of proteins during aging.Experim.Gerontol. 36: 1495-1502.

[29] Levine, R. L. 2002. Carbonyl modified proteins in cellular regulation, aging, and disease.Free Radic. Biol. Med. 32: 790-796.

[30] Vuorela, S., Salminen, H., Makela, M., Kivikari, R., Karonen, M. and. Heinonen, M. 2005b.Effect of plant phenolics on protein and lipid oxidation in cooked pork meat patties. J. Agric.Food Chem. 53: 8492-8497.

[31] KURTH, E. F. and FRANK L. CHAN, (1951). Dihydroquercetin as on Antioxidant. Journal of the American Oil Chemists' Society, Volume 28, Number 10 , pages 433-436.

[32] Kennedy, R. W. (1956). Fungicidal toxicity of certain extraneous components of Douglas-fir heartwood.For. Prod. J. 6: 80-84.

[33] Dangles, 0. and Dufour, C. 2006. Flavonoid-protein interactions. In: Flavonoids: chemistry,biochemistry and applications. Andersen, Ø. M.,Markham, K. R., Eds., CRC Press, BocaRaton, Fla., USA.

[34] Fernandez. M. T., Mira, M. L., Florencio, M. H. and Jennings, K. R. 2002. Iron and copperchelation by flavonoids: an electrospray mass spectrometry study. J. Inorg. Biochem. 92:105-111.

[35] Yoshinosuke NAGATA, Koichiro KITAO and Isamu TACHI,(1957). Polarographic Studies on the Heartwood Flavonoids 11. Copper Chelate Compounds with Dihydroquercetin and Quercetin. WOOD RESEARCH NO. 19.

[36] Cao, G., Sofic, E. and Prior, R. L. 1997. Antioxidant and prooxidant behavior of flavonoids:Structure-activity relationships. Free Radical Biol. Med. 22: 749-760.

[37] Almajano, M. P. and Gordon, M. H. 2004. Synergistic effect of BSA on antioxidant activitiesin model food emulsions. J. Am. Oil Chem. Soc. 81: 275-280.

[38] Rababah, T., Hettiarachchy, N., Horax, R., Eswaranandam, S., Mauromoustakos, A.,Dickson, J. and Niebuhr, S. 2004. Effect of electron beam irradiation and storage at 5° C. onthiobarbituric acid reactive substances and carbonyl contents in chicken breast meat infusedwith antioxidants and selected plant extracts. J. Agric. Food Chem. 52: 8236-8241.

[39] Yeomans, V. C., Linseisen, J. and Wolfram, G. 2005. Interactive effects of polyphenols,tocopherol and ascorbic acid on the Cu2+-mediated oxidative modification of human lowdensity lipoproteins. Eur. J. Nutr. 44: 422-428.

[40] Dziedzic, S. Z. and Hudson B. J. F., 1983b. Polyhydroxy chalcones and flavonones as antioxidants for edible oils. Food Chem., 12:205-212.

[41] V. Fogliano, P. Vitaglione. (2005). Functional foods: Planning and development, Mol. Nutr. Food Res. 49. 256-262.

[42] C. S. Brennan, L. J. Cleary. (2005). The potential use of cereal (1-3, 1-4)-beta-D-glucans as functional food ingredients, J. Cereal Sci., 42, 1-13.

[43] I. A. Brownlee, A. Allen, J. P. Pearson, P. W. Dettmar, M. E. Havler, M. R. Atherton, E. Onsoyen. (2005). Alginate as a source of dietary fiber, Crit. Rev. Food Sci. Nutr., 45, 497-510.

[44] E. E. Nifant'ev, M. P. Koroteev, G. Z. Kaziev, A. A. Uminskii, A. A. Grachev, V. M. Men'shov, Yu.E. Tsvetkov, N.E. Nifant'ev, V. K. Bel'skii, A. I. Stash. (2006). On the Problem of Identification of the .Dihydroquercetin Flavonoid. ISSN 1070-3632, Russian Journal of General Chemistry, 2006, Vol. 76, No. 1, pp. 161- 163. Pleiades Publishing, inc., 2006. Original Russian Text published in Zhurnal Obshchei Khimii, 2006, Vol. 76, No. 1, pp. 164 -166.

[45] Pew, John C., 1947. A flavanone from Douglas-fir heartwood. J. Am. Chem.. Soc., 70 (9), pp 3031-3034.

[46] E. F. Kurth, Harry J. Kiefer, and James K. Hubbard, (1948).Utilization of Douglas-fir Bark The Timberman, Vol. 49, No. 8, pp. 130-1.

[47] H. M. Graham, E. F. Kurth, (1949). Constituents of Extractives from Douglas Fir. Ind. Eng. Chem., 41 (2), pp 409-414.

[48] Migita, Nobuhiko,-Nakano, Junzs, Sakai, Isamu, and Ishi, Shoichi. (1952). Japan Tech. Assoc. Pulp Paper Ind. 6:476-480.

[49] Kurth, E. F., and Chan, F. L., (1953). “Extraction of Tannin and Dihydroquercetin from Douglas Fir Bark.”J. Amer. Leather Chem. Assoc. 48(1):20-32, Abstr. Bull. Inst. Pap. Chem. 23:469.

[50] G. M. Barton, J. A. F. Gardner. (1958). Determination of Dihydroquercetin in Douglas Fir and Western Larch Wood. Anal. Chem., 30 (2), pp 279-1281.

[51] G. V. Nair and E von Rudloff. (1959). THE CHEMICAL COMPOSITION OF THE HEARTWOOD EXTRACTIVES OF TAMARACK (.LARIX LARICINA (DU ROI) K. KOCH)1. Can. J. Chem., Vol. 37, pp. 1608-1613.

[52] Tyukavkina, N. A., Lapteva, K. I., Larina V. A.,(1967). Extractives of Larix dahurica.Quantitative content of quercetin and dihydroquercetin.Chemistry of Natural Substances. Issue 5, pages 298-301.

[53] Haraguchi H. Mochida Y, Sakai S. Masuda H, Tamura Y, Mizutani K, Tanaka O, Chou WH. (1996). Protection against oxidative damage by dihydroflavonols in Engelhardtia chrysolepis. Biosci Biotechnol Biochem., 60(6):945-8.)

[54] Kostyuk V A, Potapovich A I. (1998). Antiradical and chelating effects in flavonoid protection against silica-induced cell injury. Arch Biochem Biophys., 355(1):43-8.

[55] Godley, Bernard F, and Shamsi. Farrukh Anis and Liang, Fong-Qi and Jarrett, Stuart Gordon and Davies, Sallyanne and Boulton, Michael Edwin. (2005). Blue light induces mitochondrial DNA damage and free radical production in epithelial cells. Journal of Biological Chemistry. 280 (22). pp. 21061-21066. ISSN 00219258.

[56] Xinyu JIANG. Xiaoqing CHEN * and Yan WEI.(2009). Free Radical Scavenging Activity and Flavonoids Contents of Polygonum orientale Leaf, Stem and Seed Extracts. Lat. Am. J. Pharm. 28 (2): 284-7.

[57] Iskandarov, A. I., Abdukarirnov, B. A. (2009). Influence of Dihydroquercetin and ascorbic acid on the content of malon dialdehyde and metallothionein in rat's organs exposed to chronic cadmium impact. Journal Toxicological Vestnik, volume 4. Russian language version.

[58] Yifan Chen. (2009). Antioxidants quercetin and dihydroquereetin inhibit ex vivo homolysis but not plasma lipid peroxidation. FASEB J. 23: 966.3.

[59] Bronnikov, G. E., Kulagina, T. P., Aripovsky, A. V. (2009). Dietary Supplementation of Old Mice with Flavonoid Dihydroquercetin Causes Recovery of Mitochondrial Enzyme Activities in Skeletal Muscles. ISSN 1990-7478, Biochemistry (Moscow) Supplement Series A: Membrane and Cell Biology, 2009, Vol. 3, No. 4, pp. 453-458. © Pleiades Publishing, Ltd.Russian language version. Original Russian Text © G. E. Bronnikov, T. P. Kulagina, A. V. Aripovsky, 2009, published in Biologicheskie Membrany, 2009, Vol. 26, No. 5, pp. 387-393. Russian language version.

[60] KURTH, E. F. and FRANK L. CHAN, (1951). Dihydroquercetin as on Antioxidant, Journal of the American Oil Chemists' Society, Volume 28, Number 10 , pages 433-436.

[61] H. R. Kraybill, L. R. Dugan. (1954). Antitoxidants, New Developments for Food Use. J. Agric. Food Chem., 2 (2), pp 81-84.

[62] A. Tamsma, T. J. Mucha, and M. J. Pallansch.(1963). FACTORS RELATED TO THE FLAVOR STABILITY DURING STORAGE OF FOAM-DRIED WHOLE MILK. 111. EFFECT OF ANTIOXIDANTS. Dairy Products Laboratory, Eastern Utilization Research and Development Division, USDA Washington, D.C. Journal of Dairy Science, Vol. 46 No. 2 114-119.

[63] RAJAN, T. S., Richardson, G. A., Stein, R. W. (1961). XANTHINE OXIDASE ACTIVITY OF MILKS IN RELATION TO STAGE OF LACTATION, FEED, AND INCIDENCE OF SPONTANEOUS OXIDATION.Technical Notes. Department of Food Science and Technology Oregon State University, Corvallis.

[64] Richardson, G. A., and Erickson, D. R. (1959). Dihydroquercetin as an Antioxidant for Milk. J. Dairy Sci., 42: 897.

[65] Thillasthanam Seshadri Rajan. (1962). The role of dihydroquercetin as an antioxidant for some dairy products. Typescript.Thesis (Ph. D.)-Oregon State University, Bibliography: pages 113-134.

[66] Blinova, T. E., Radaeva, Zdorovtsova, A. N.(2008). Influence of Dihydroquercetin on milk-acid bacteria. J. Dairy Industry, 5, 57, 2008, Russian language version. Dairy Institute.

[67] Blinova, T. E., Radaeva, Zdorovtsova, A. N.(2008). Bactericide properties of Dihydroquerectin. J. Dairy Industry, 4, 60. Russian language version. Dairy Institute.

[68] Gurinovich, S. V.; Lisin, K. V.; Potipayeva, N. N. (2005). Preparation for increasing storage life of comminuted meat products. Myasnaya Industriya No. 2 pp. 31-33.Russian language version.

[69] Anastasiya A. Semenova, Ph.D., Tatyana G. Kuznetsova, Ph.D., Victoriya V. Nasonova. (2007). Study on possibility of dihydroquercetin application for stabilization of sausage quality manufactured with the use of MDPM. 54th International meat industry conference Belgrade, page.75

[70] Semenova A. A. (2008). “Food Additives' Evaluation for an Adequate Application in Meat Industry”.Russian language version.Russian Institute of meat Industry.

[71] IVANOV, G., D. BALEV, H. NIKOLOV and S. DRAGOEV. (2009). Improvement of the chilled salmon sensory quality by pulverisation with natural dihydroquercetin solutions. Bulg. J. Agric. Sci., 15: 154-162.

[72] van der L B, Bachschmid M, Spitzer V, et al. Decreased plasma and tissue levels of vitamin C in a rat model of aging: implications for antioxidative defense. Biochem Biophys Res Commun. 2003 Apr. 4;303(2):483-7.

[73] Potapovich A I, Kostyuk V A. Comparative study of antioxidant properties and cytoprotective activity of flavonoids.Biochemistry (Most.). 2003 .May;68(5):514-9.

[74] Kravchenko L V, Morozov S V, Tutel'yan V A. Effects of flavonoids on the resistance of microsomes to lipid peroxidation in vitro and ex vivo. Bull Exp Biol Med. 2003 December;136(6):572-5.

[75] Teselkin Y O, Babenkova I V, Tjukavkina N A, et al. Influence of dihydroquercetin on the lipid peroxidation of mice during postradiation period. Phytotherapy Research. 1998;12:517-9.

[76] Vasiljeva O V, Lyubitsky O B, Klebanov G I, Vladimirov Y A.Effect of the combined action of flavonoids, ascorbate and alphatocopherol on peroxidation of phospholipid liposomes induced by Fe2+ ions. Membr Cell Biol. 2000;14(1):47-56.

[77] Kostyuk V A, Kraemer T, Sies H. Schewe T. Myeloperoxidase/nitrite-mediated lipid peroxidation of low-density lipoprotein as modulated by flavonoids. FEBS Lett. 2003 Feb 27;537(1-3):146-50.

[78] Bjeldanes L F, Chang G W. Mutagenic activity of quercetin and related compounds.Science. 1977 Aug 5:197(4303):577-8.

[79] Nagao M, Morita N, Yahagi T, et al. Mutagenicities of 61 flavonoids and 11 related compounds. Environ Mutagen. 1981;3 (4):401-19.

[80]Booth A N. Deeds F. The toxicity and Metabolism of dihydroquercetin. J Am Pharm Assoc Am Pharm Assoc (Baltim.). 1958 March; 47(3, Part 1):183-4.

[81]William S. Branham, Stacey L. Dial, Carrie L. Moland, Bruce S. Hass, Robert M. Blair, Hong Fang, Leming Shi, Weida Tong, Roger G. Perkins and Daniel M. Sheehan. (2002). Phytoestrogens and Mycoestrogens Bind to the Rat Uterine Estrogen Receptor. Biochemical and Molecular Action of Nutrients, © 2002 American Society for Nutritional Sciences.

[82]Wendy N. Jefferson, Elizabeth Padilla-Banks, George Clarkb, Retha R. Newbold. (2002). Assessing estrogenic activity of phytochemicals using transcriptional activation and immature mouse uterotrophic responses. Journal of Chromatography B, 777, pp. 179-189.

[83]Wim Watjen, Gudrun Michels, Barbel Steffan, Petra Niering, Yvonni Chovolou, Andreas Kampkotter, Quynh-Hoa Tran-Thi, Peter Proksch, and Regine Kahl. (2005). Low Concentrations of Flavonoids Are Protective in .Rat H.4IIE Cells Whereas High Concentrations Cause DNA Damage and Apoptosis J. Nutr. 135: 525-531.

[84]Kathrin Plochmanna, Gabriele Korte, Eleni Koutsilieri, Elke Richling, Peter Riederer, Axel Rethwilm, Peter Schreier and Carsten Scheller. (2007). Structure-activity relationships of flavonoid-induced cytotoxicity on human leukemia cells. Archives of Biochemistry and Biophysics,

Volume 460, Issue 1, Pages 1-9.

[85]Stavreva, M., et al. (2008). Protocol on Toxicological Investigations and Safety Evaluation of DHQ for application in food products, National Center of Public Health and Nutrition, Director Ivanov, L., Ministry of Health, Sofia, Bulgaria.Agreement No. 034-P-2007.Bulgarian language version.

[86]Zhanataev, A. K., Kulakova, A. V., Nasonova, V. V., Durnev, A. D., (2008). In Vivo Study of Dihydroquercetin Genotoxicity. Bulletin of Experimental Biology and Medicine, 145, 3, 309-312.PHARMACOLOGY AND TOXICOLOGY.

[87]Makena, Patrudu S; Pierce, Samuel C; Chung, King-Thom; Sinclair, Scott E; (2009). Comparative mutagenic effects of structurally similar flavonoids quercetin and taxifolin on tester strains Salmonella typhimurium TA102 and Escherichia coli WP-2 uvrA. Environmental and molecular mutagenesis (Environ Mol Mutagen), vol. 50 (issue 6): pp. 451-9.

[88] Ponder G R, Richards G N (1997a) Arabinogalactan from Western larch, Part II; a reversible order-disorder transition. J Carbohydr Chem 16:195-211.

[89] Kara'csonyi S, Kova'cik V, Alfo\ddot{}ldi J, Kubackova' M (1984) Chemical and 13C-N.M.R. studies of an arabinogalactan from Larix sibirica L. Carbohydr Res 134:265-274.

[90] Simionescu C, Sang II B, Cernatescu-Asandei A (1976) Researches in the field of chemistry and technology of larch wood pulping by magnesium bisulphite process. II. Structure of arabinogalactan from larch wood (Larix decidua Mill). Cellulose Chem. Technol., 10:535-545.

[91] Odonmazig, P. Ebringerova, A. Machova, E. Alföldi, J. (1994) Structural and molecular properties of arabinogalactan isolated from Mongolian larchwood (Larix dahurica L.). Carbohydr. Res. 252: 317-324.

[92] Fitzpatrick A., Roberts A and Witherly S. (2004). Larch Arabinogalactan: a novel and multifunctional natural product. Agro Food industry Hi-Tech 15(1):30-32.

[93] Ohr L. M. Arabinogalactan Adds More than Health Benefits//Prepared Foods. 2001. V. 170. No. 1.P. 55.

[94] Loosveld A.-M.A., Delcour A. The significance of arabinogalactan-peptide for wheat flour bread-making//Journal of Cereal Science. 2000. V. 32. No. 2, P. 147-157.

### FIELD OF THE INVENTION

The present invention is directed to the use of hardwood extracts such as Dihydroquercetin (taxifolin), Arabinogalactan and Arabinogalactan in combination with Dihydroquercetin (taxifolin) for applications in food products, wherein hardwood extracts are suggested touse as dietary ingredients, naturalantioxidants, food additives and food preservatives. Conifer wood species, especially those from the family of Pinaceae are considered rich sources of nutritional compounds. The emphasis is put on residues of wood transformation such as bark, butt logs, roots and knotwood as these materials represent particularly rich resources for flavonoids, particularly Dihydroquercetin (taxifolin) and dietary fibers, particularly Arabinogalactan and Arabinogalactan in combination with Dihydroquercetin (taxifolin).

### BACKGROUND OF THE INVENTION

It is known that the forest biomass is the most important biomass on Earth, and as wood industry is generating the huge amounts of residues, which are available as an important vegetable resource for further processing and valorization of dietary ingredients through extraction. The extractable flavonoids, obtainable by solvent extraction of the forest biomass, are of special interest as they are readily available from different types of forest and wood transformation residues. One of the most notorious bioactive properties of flavonoids is their antioxidant activity. The most important results on antioxidant capacity of forest trees extracts are presented and compared to those obtained for the extracts from healthy foods rich in bioactive flavonoid molecules [1]. Flavonoid Dihydroquercetin (taxifolin) is one of the most effective natural antioxidant and anti-inflammatory compound [2,3].The emphasis is also put on residues of conifer wood transformation such as butt logs and bark as these materials represent particularly rich resources for mainly of the dietary fiber arabinogalactan [4,5,6,7,8]. Higher arabinogalactan content often goes hand in hand with higher amount of flavonoid substances such as Dihydroquercetin (taxifolin) [9], which had been noted in the literature [10-22] to occur in a hardwood, including stems, bark and roots.

Oxidative reactions of lipids and proteins are a major cause of chemical deterioration in food. Free radical mediated oxidation of lipids and proteins arise from reactive oxygen species (ROS)generated during food processing and storage [23,24]. Free radicals derived from lipid oxidation reactions are easily transferred to other molecules such as proteins, carbohydrates and vitamins, especially in the presence of metal ions [25]. The nature and extent of reactions involved in food processing depend on the ingredients as well as the processing conditions. The oxidative attacks on macromolecules contribute to deterioration of flavor, aroma, color (unwanted browning reactions), and nutritive value. The protein oxidation leads to loss of amino acids and solubility, changes in texture, alterations in protein functionality and may even lead to formation of toxic compounds [26,27].Living organisms are also exposed to ROS. Oxidation of proteins in human body has been linked to changes occurring during aging, and particularly in a variety of diseases and disorders, e.g., infectious diseases, autoimmune diseases as well as neuropsychiatric and neurological disorders[28,29].In order to prevent and control lipid and/or protein oxidation, antioxidant compounds can be added to foods. In recent years the consumer demand for “all natural” products has increased.

Therefore, natural plant materials could provide an alternative to synthetic food additives. Plant materials richin flavonoid compounds exhibit a wide range of activities such as antioxidant, antimicrobial, antimutagenic, as well as anti-inflammatory activities [30,31,32]. Flavonoid compounds act as antioxidants by donating electrons or a hydrogen atom and terminating radical chain reactions [33], as well as chelators by binding metal ions [34,35]. In food, antioxidants occur either as endogenous constituents or are added for enhancing product quality by controlling oxidation with its deleterious consequences. The ideal food grade antioxidant should be safe and not impart color, odor or flavor. It should also be effective at low concentrations, be easy to incorporate into foods, survive harsh processing conditions, be stable in the finished product and available at low cost. Whilst antioxidants are often added to foods to stabilize them and prevent for instance off-flavor development, considerable interest has been expressed for their potential role as therapeutic agents. Consequently, antioxidants are of interest to both food scientists and health professionals.

The process of auto-oxidation of polyunsaturated lipids in food involves a free radical chain reaction that is generally initiated by exposure of lipids to light, heat, ionizing radiation, metal ions or metalloprotein catalysts. Enzyme lipoxygenase can also initiate oxidation. The classical route of auto-oxidation includes initiation (production of lipid free radicals), propagation and termination (production of non-radical products) reactions [FIG. 1].Lipid oxidation products generate multiple reactive species such as hydroperoxides, peroxyl and alkoxyl radicals, carbonyl compounds as well as epoxides which can easily react with non-lipidmolecules such as proteins. Proteins in food, cosmetics and pharmaceuticals are prone to oxidation reactions as well [FIG. 2]. During food processing and storage and in vivo, proteins are modified, for example, via oxidation, glycation and glycoxidation reactions. Free radical mediated oxidation of amino acids and proteins arise from ROS generated as byproducts of normal metabolic processes, or external factors such as processing (e.g. heating, fermentation, application of chemicals), photochemical reactions, the presence of oxygen, air pollutants, and irradiation (γ-, x-, and UV) [23,24].The oxidation of proteins, peptides and amino acids leads to altered physicochemical and functional properties, and may even result in formation of toxic compounds [26,27]. Oxidation of proteins has also been linked to changes occurring during aging, particularly with prOgression of diseases and disorders in humans [28,29].The oxidation of proteins leads to damage of amino acids and decreased solubility resulting in aggregation of proteins, changes in food texture, alterations in tissue and membrane structures, changes in protein functions such as inactivation of enzymes, and formation of toxic products. Oxidative modifications in foods leading to the deterioration of structure, flavor, aroma, loss of nutritive value and alterations in protein functionality are a great concern to food industry. Functional properties important to food processing such as gelling, foaming, water-holding capacity and ability to act as surfactant are greatly affected by lipid oxidation products.

The overall antioxidant mechanism of flavonoids is recognized as a combination of a direct reaction with free radicals and chelation of metal ions [33,34].Modifications of proteins and lipids are frequently influenced by redox cycling transition metal ions. Flavonoids primarily chelate prooxidant transition metal ions such as Fe2+, Fe3+ and Cu2+ and alter their redox potentials rendering them inactive in generating free radicals [33]. Same flavonoids can behave as both antioxidants and prooxidants, depending on the concentration and free radical source. In a study by Cao et al. (1997) [36], flavonoids acted as antioxidants against free radicals but demonstrated prooxidant activity when transition metal ions were available. This is because the flavonoid may react directly with the transition metal ions and affect the rate of related free radical generation. It has been shown that if the metal-flavonoid-complex still undergoes redox reactions, the free radicals generated can be scavenged by the ligand itself since metal-flavonoid chelates are considerably more potent free radical scavengers than the parent flavonoids [33].The role of flavonoid antioxidants on protein oxidation has been studied in different oxidation models such as oil-in-water emulsions, meat, liposomes and LDL [37,38,39]. In flavonoid molecule [FIG. 3], the antioxidant and metal chelating properties are mainly due to the 3′,4′-dihydroxy group located on the B ring, the 3-hydroxy or 5-hydroxy and the 4-carbonylgroups in the C-ring [FIG. 3]. In addition, the antioxidant activity increases with the number of hydroxyl groups in rings A and B [FIG. 3].

It was suggested that dietary fiber from hardwood of coniferous species has application in a variety of foods, beverages and nutraceuticals as a result of its unique physical characteristics. Under Section 610 Arabinogalactan (21 CFR 172.610) USFDA 2004a it is used in the following foods in the minimum quantity required to produce its intended effect as an emulsifier, stabilizer, binder, or bodying agent: Essential oils, non-nutritive sweeteners, flavor bases, non standardized dressings and puddina mixes. In food, dietary fiber from hardwood is neutral in taste, odor and color. It is used as an emulsifier, stabilizer, binder or bonding agent in essential oils, humectants, non-nutritive sweetener, flavor base, processing aid and stabilizer. It enhances shelf-life of many types of goods. It retains moisture and enhances mouth feel and texture. Texture is improved in the baked foods by reducing the stickiness of the dough and improving the external symmetry and internal grain scores. Water soluble dietary fiber from hardwood became popular for enrichment by minerals, antioxidants and vitamins for especial application for enrichment of wheat flour for the bakery and for usage as food additive for beverages, dairy products. Dietary fiber from hardwood is highly water-soluble, readily disperses in a hot or cold beverage within 30 seconds (being in agglomerated form) and remains clear in solution and does not cause turbidity or precipitate out of solution. It may be added to a beverage up to 60% of the daily reference value (DRV) for fiber without increasing its viscosity. The DF will not hydrolyze at a low pH. DF is non-reactive making it ideal for beverage mixes, refrigerated or shelf-stable ready to drink beverages. It is heat stable up to 121° C. and can be heat pasteurized. In confectionary foods, DF from hardwood lowers water activity and aids in flavor and oil retention. It has also been used to increase the stability of oils (by mixing or co-spray drying) that are often sensitive to degradation. DF is used in browning compositions for uncooked foods, in seasoning powders to improve flow and reduce hydroscopicity, and in starch containing foods to inhibit swelling. Being a highly soluble fiber with a very low viscosity, DF from hardwood leaves no negative impact on mouth feel. It can be exposed to high heats and can be withstand the rigours of an extrusion process.

There are three main strategies for functional food design: (i) to modify the composition of raw material, (ii) to modify the technological processes (create specific processes to allow or enhance the formation of compounds having specific biological activities), and (iii) to modify the formulation of the recipes. In the last case, the addition of so-called functional ingredients such as DF from hardwood to a traditional food matrix is the simplest and most common way to realize a functional food. However, the simple addition of a functional ingredient should be performed taking into account many variables such as the interaction with the food matrix, the stability of the process, and bioavailability of functional ingredients in the final product [41]. In the past, scientific evidence exalting the physiological effects of dietary fibers (DFs) [such as reduction of bowel transit time, prevention of constipation, reduction in risk of colorectal cancer by the increase of the fecal and colon mass, production of short chain fatty acids (SCFAs), lowering blood cholesterol, regulation of blood glucose levels for diabetes management, promotion of colon functionality, increase of beneficial colonic micro-flora growth (i.e. as prebiotic)] was shown to convince the food industry to use DFs not only to improve the physical characteristics of their products but also to improve food nutritional properties [42]. Soluble DFs lower the rate of intestinal absorption of metabolizable nutrients, thereby reducing the glycemic load on the body. In turn, this necessarily reduces the level of insulin response. DFs increase the number of colonic crypts (increase colonic surface area). They have been implicated in modulating the colonic mucus barrier, the first line of defense that the colonic mucosa has to luminal aggression [43].

Before this invention, it has been known that the extracts of different parts of conifer wood species contain a variety of compounds, such as natural antioxidant Dihydroquercetin (taxifolin), natural non-starch polysaccharide arabinogalactan, which is a soluble dietary fiber and dietary fiber arabinogalactan from hardwoods, mainly from Larix dahurica (Larix gmelinii), Larix sibirica. Larix sukaczewii larch wood species, i.e. larch arabinogalactan can be defined as a fiber containing significant amounts of natural antioxidants, mainly

Dihydroquercetin (taxifolin) associated naturally to the fiber matrix with the following specific characteristics: 1. Dietary fiber content, higher than 70% dry matter basis. 2. One gram of dietary fiber larch arabinogalactan should have a capacity to inhibit lipid oxidation equivalent to, at least, 1,000 umol TE/gram basing on ORAC value and normally to 2,000-4,000 umol TE/gram 3. One gram of dietary fiber larch arabinogalactan should have a capacity of Cell-based Antioxidant Protection (CAP-e) to protect live cells from oxidative damage to, at least 6 CAP-e units per gram, where the CAP-e value is in Gallic Acid Equivalent (GAE) units. 4. The antioxidant capacity must be an intrinsic property, derived from natural constituents of the material (soluble in digestive fluids) not by added antioxidants or by previous chemical or enzymatic treatments. This invention relates to the use of hardwood extracts such as Dihydroquercetin (taxifolin), Arabinogalactan and Arabinogalactan in combination with Dihydroquercetin (taxifolin) for applications in food products, wherein hardwood extracts are suggested to use as dietary ingredients, natural antioxidants, food additives and food preservatives.

### SUMMARY OF INVENTION

The present invention relates to antioxidant and dietary fiber compounds derived from a plant material, wherein the said antioxidant and dietary fiber compounds comprising flavonoid Dihydroquercetin (taxifolin) and polysaccharide Arabinogalactan consequently extracted from byproducts of logging industry or from hardwood, preferably obtained from extracts of Conifer wood species, especially those from the family of Pinaceae, most preferably from Larix dahurica (Larix gmelinii), Larix sibirica, Larix sukaczewii species, most preferably using only water—ethanol extraction and/or water extraction, heating and/or heating under vacuum and compression of the wood, used for application in food products as dietary ingredients, natural antioxidants, food additives and food preservatives.

It is therefore a purpose of this invention to use Dihydroquercetin (taxifolin), Arabinogalactan and Arabinogalactan in combination with Dihydroquercetin (taxifolin) for applications in food products during processing of the food, wherein any of above ingredients not normally consumed as a food in itself and not normally used as a characteristic ingredients of a food whether or not it has nutritive value, the intentional addition of which to food for a technological purpose in the manufacturing, processing, preparation, treatment, packaging, transport or storage of such food results, or may be reasonably expected to result, in it or its by-products becoming directly or indirectly a component of such foods.

One aspect of the present invention provides the inclusion of Dihydroquercetin (taxifolin), Arabinogalactan and Arabinogalactan in combination with Dihydroquercetin (taxifolin) into food or food matrix to achieve the following criteria:

to demonstrate a reasonable technological need;

to present no hazard to the health of the consumer at the level of use proposed, so far as can judged on the scientific evidence available; and

to do not mislead the consumer.

Another aspect of the present invention provides the use of Dihydroquercetin (taxifolin), Arabinogalactan and Arabinogalactan in combination with Dihydroquercetin (taxifolin) in food products or food is considered following the evidence that the proposed use of the above ingredients have demonstrable benefit to the consumer. The use of Dihydroquercetin (taxifolin), Arabinogalactan and Arabinogalactan in combination with Dihydroquercetin (taxifolin) serve one or more of the purposes set out below:

To preserve the nutritional quality of the food, wherein an intentional reduction in the nutritional quality of a food is justified only where the food does not constitute a siunificant item in a normal diet or where the ingredients are necessary for the production of foods for groups of consumers having special dietary needs.

To provide mentioned ingredientsor constituents of foods manufactured for groups of consumers having special dietary needs;

To enhance the keeping quality or stability of a food or to improve its organoleptic properties, without change the nature, substance or quality of the food, including purposes to ingredients be used as antioxidants toprolong the shelf-life of foodstuffs by protecting them against deterioration caused by oxidation and preservatives to prolong the shelf-life of foodstuffs by protecting them against deterioration caused by microorganisms;

To provide aids in manufacture, processing, preparation, treatment, packing, transport or storage of food.

Preferably, Arabinogalactan and Arabinogalactan in combination with Dihydroquercetin (taxifolin) are present in the food or food matrix in an amount from about 0.5% solids to about 30% solids. In another embodiment, the ingredient is essentially arabinogalactan-free. By “essentially arabinogalactan-free” it is meant that the ingredient contains about 1% or less of arabinogalactan. In this instance, the ingredient is Dihydroquercetin (taxifolin) and is preferably present in the food or food matrix in an amount from about 0.005% solids to about 5.0% solids.

Preferably, Dihydroquercetin (taxifolin), Arabinogalactan and Arabinogalactan in combination with Dihydroquercetin (taxifolin)are obtained from a wood of Conifer wood species, especially those from the family of Pinaceae, most preferably from Larix dahurica (Larix gmelinii), Larix sibirica, Larix sukaczewii species. Typically, the ingredients are in a form of powder of the extract. Alternatively, the ineredients can be applied as an aqueous solution to the food.

In further embodiments of the present invention also derivatives such as esters and physiologically/nutraceutically/technologically acceptable salts of Dihydroquercetin (taxifolin), Arabinogalactan, and Arabinogalactan in combination with Dihydroquercetin (taxifolin) may be used instead of ingredients Dihydroquercetin (taxifolin), Arabinogalactan, and Arabinogalactan in combination with Dihydroquercetin (taxifolin). It is also possible to use a mixture of ingredients and their derivatives.

The ingredients and/or their derivatives and/or mixture of ingredients and their derivatives may be applied to the food product by mixing them with the food so that ingredients are retained with the food in an amount effective to achieve above objects or purposes of present invention. Alternatively, the ingredients and/or their derivatives and/or mixture of ingredients and their derivatives can be applied using a technique selected from the group including spraying, dipping, rinsing, brushing, or a combination thereof.

Another aspect of the present invention provides the ingredients to achieve above objects or purposes of present invention comprising a wood extracts Dihydroquercetin (taxifolin). Arabinogalactan and Arabinogalactan in combination with Dihydroquercetin (taxifolin) obtained from extracts of Conifer wood species, especially those from the family of Pinaceae, most preferably from Larix dahurica (Larix gmelinii), Larix sibirica, Larix suLaczewii species. The wood extracts Arabinogalactan and Arabinogalactan in combination with Dihydroquercetin (taxifolin) are present in the food or food matrix in an amount from about 0.5% solids to about 30% solids. If extract is essentially arabinogalactan-free that is Dihydroquercetin (taxifolin) is preferably present in the food or food matrix in an amount from about 0.005% solids to about 5.0% solids.

In accordance with the present invention, the food or food product can be any substance consumed to provide nutritional support for the body. It is usually of plant or animal origin, and contains essential nutrients, such as carbohydrates, fats, proteins, vitamins, or minerals. The substance is ingested by an organism and assimilated by the organism's cells in an effort to produce energy, maintain life, or stimulate growth.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 depicts general scheme of auto-oxidation of lipids containing polyunsaturated fatty acids (RH) and their consequences.

FIG. 2 depicts protein oxidation pathways via A) free radical transfer, B) oxidation, and C) cross linkin. In FIG. 2, PH=protein, P.=protein radical, AH=any molecule with abstractable hydrogens, A.=non-protein radical, PO.=alkoxyl radical, POO.=peroxyl radical, POOH=hydroperoxide, P—CH═O=secondary products such as aldehydes.

FIG. 3 depicts Dihydroquercetin (taxifolin) molecule structure and molecule hydroxyl groups.

FIG. 4 shows an example of antioxidant expectations check-in according Rancimat trials with Dihydroquercetin (taxifolin)—DHQ.

FIG. 5 shows an example of DPPH test on DIHYDROQUERCETIN (TAXIFOLIN) comparing to antioxidant capacity of Vitamin C.

FIG. 6 illustrates ORAC and CAP-e antioxidant tests conducted on Dihydroquercetin (taxifolin).

FIG. 7 shows Dihydroquercetin (taxifolin)'s cell-based antioxidant protection (CAP-e) peroxyl.

FIG. 8 depicts the results obtained in vitro and presented in the following order: the antioxidant capacities as determined by the TRAP, TEAC, and deoxyribose assays.

FIG. 9 shows ORAC values of a variety of foods.

FIG. 10 depicts Arabinogalactan in combination with Dihydroquercetin (taxifolin)—Cell-based Antioxidant Protection (CAP-e) peroxyl.

FIG. 11 depicts positive bactericide effects of Dihydroquercetin (taxifolin) in yogurts.

FIG. 12 Forecasted shelf life (SL) for swine raw fat (a) and poultry meat after rolling (b).

FIG. 13 shows an example of application Dihydroquercetin (taxifolin) or DHQ and Larch Arabinogalactan or LAG in juice concentrates, i.e., a strawberry juice concentrate.

### DETAILED DESCRIPTION OF THE PREFERRED EMBODIMENTS AND THE DRAWINGS

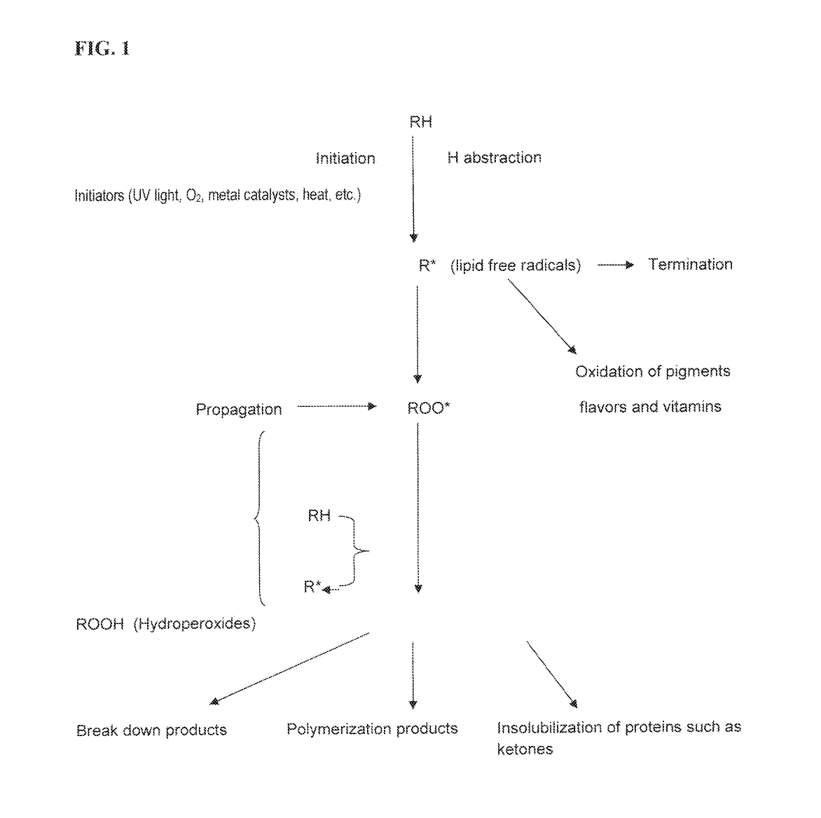

FIG. 1 schematically illustrates the general scheme of auto-oxidation of lipids containing polyunsaturated fatty acids (RH) and their consequences. There are two basic types or causes of rancidity that cause and/or contribute to the degradation of stored edible oils: oxidative and hydrolytic. Hydrolytic rancidity, also called hydrolysis or enzymatic oxidation, occurs in the absence of air, but with moisture present. This normally is accomplished through enzymatic peroxidation, where enzymes found naturally in plant oils (i.e., lipoxygenase, cyclooxygenase) and animal fats (i.e., lipase) can catalyze reactions between water and oil. Another degradation process is microbial rancidity, in which micro-organisms such as bacteria, molds and yeast use their enzymes to break down chemical structures in the oil, producing unwanted odors and flavors.

As mentioned above, the main cause of rancidity of lipids is the oxidative deterioration of unsaturated fatty acids via a free-radical chain mechanism, also called lipid peroxidation. It occurs in three stages or phases. The first is the initiation (induction) stage, whereby molecular oxygen combines with unsaturated fatty acids, producing hydroperoxides and peroxyl free radicals, both of which are highly reactive and unstable. The second stage is called propagation. This is when these unstable byproducts of the first stage react with other lipids, starting a continuing free radical lipid peroxidation chain reaction called auto-oxidation. This results in a continuing and cyclical oxidative degradation process, breaking down the lipid. The final stage, termination, is marked by the slowing or stopping of reactions, completion of making unreactive compounds (e.g. amides, alcohols, aldehyedes, hydrocarbons, ketones, etc.) or when an antioxidant is added or encountered. There are two basic types of oxidative byproducts, primary and secondary. Primary oxidative products are fatty acids reacting with oxygen-forming peroxide compounds. Primary oxidation byproducts include peroxides (ROO) and hydro-peroxides (ROOH). Secondary oxidation products occur when ROOH degrade further into other substances, primarily carbonyl compounds: volatile and non-volatile aldehydes, amide, carboxylic acids, expoxides, ketones, alcohols and hydrocarbons (alkanes and alkenes).

Hydrolysis is caused by hydrolysis of the triglycerides in the oil into their component fatty acids and glycerol. The process occurs without oxygen and in the presence of moisture over time, the rate is accelerated by temperature (increase) or a catalyst. These catalysts are usually enzymes (lipase, esterase, lipoxygenase, cyclooxygenase, etc.) or acidic in nature. Lipase in stored oil, for example, usually comes from a bacterial contamination. Lipoxygenase or cyclooxygenase typically come from plant-based oils. A list of catalyst agents is mentioned earlier in this disclosure. These free fatty acids then undereo further secondary auto-oxidation. Hydrolytic rancidity is more of an issue in animal fats than for vegetable fats.

Microbial Rancidity is caused by micro-organisms (bacteria, mold, and yeast) multiplying in oils after exposure to moisture (water). Bacteria and fungi are everywhere (in water, air, equipment, on people, etc.). These micro-organisms use their enzymes (e.g. lipases) to break down the chemical structures in the oil, resulting in undesirable odors and flavors. The amount of harm done depends upon the type of micro-organism, their numbers, and the physical condition of the oil being stored.

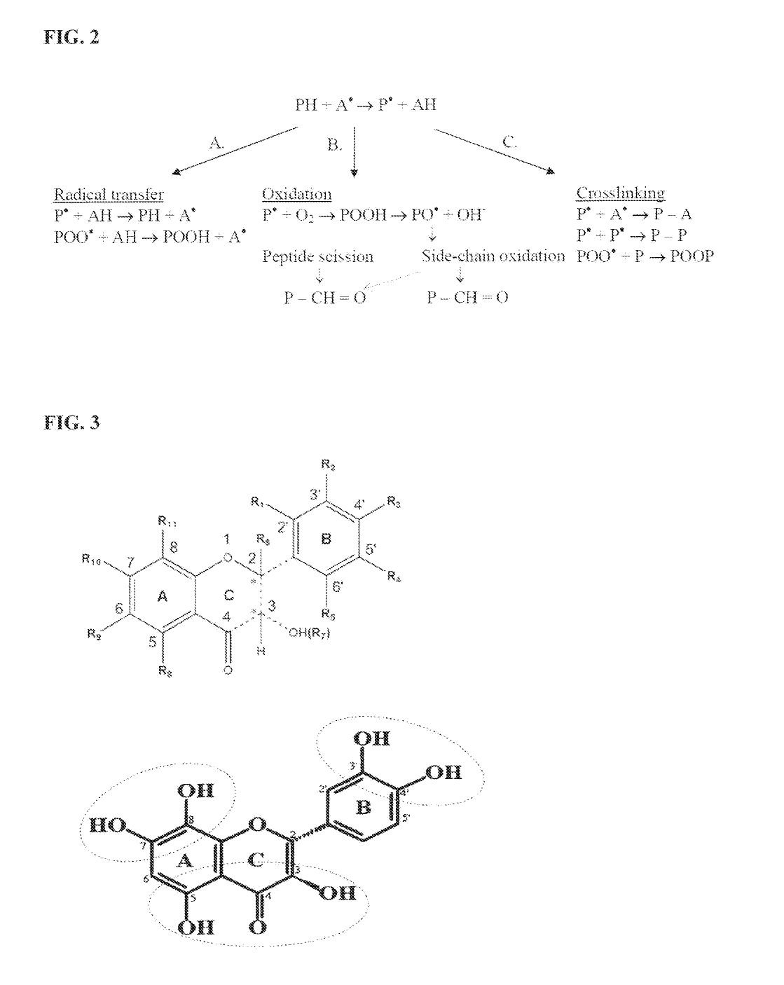

FIG. 2 shows protein oxidation pathways via A) free radical transfer, B) oxidation, and C) cross-linking (Adapted from Karel et al., 1975, and Schaich, 2008). Protein radicals (P.) are formed when lipid peroxyl and alkoxy radicals arise from lipid hydro-peroxides, and transfer .free radicals to proteins by abstracting hydrogens (Karel et al., 1975). Protein hydro-peroxides (POO.) and other protein radicals (P.) are highly reactive, and thus oxidize to secondary compounds (Davies et al., 1995). The peptide bond in the backbone of the protein or the side-chains of the amino acids may be the target for amino acid modifications. The oxidative modification can cause cleavage of the protein backbone and cross linking of the side chains. The reactions are usually highly influenced by redox cycling metals such as iron and copper. In addition, protein radicals can also transfer radicals to other proteins, lipids, carbohydrates, vitamins and other molecules, especially in the presence of metal ions. Radical transfer occurs early in lipid oxidation, and this process underlies the antioxidant effect for lipids. Consequently, it may appear that lipid oxidation is not proceeding whereas the radical transfer to proteins is in its highest (Schaich, 2008). Reactions between proteins and free radicals and ROS suggest that proteins could protect lipids from oxidation ifthey are oxidized preferentially to unsaturated fatty acids. Protein oxidation could be favored if amino acids are more labile than unsaturated fatty acids, or if the location of the protein enables it to scavenge the free radicals or ROS before they migrate to the lipids (Elias et al., 2008).

FIG. 3 shows the molecular structure of flavonoid, Dihydroquetcetin (taxifolin), and its molecule hydroxyl groups. “*” in FIG. 3 denotes the chiral center.

The flavonoids are derivatives of phenylpropanoid metabolism. Their structures are based on C6-C3-C6 skeletons, the A ring of the flavonoid structure being acetate derived (3×C2) and the C and B rings originating from cinnamic acid derivatives (phenylpropanoid pathway). The flavonoids constitute an enormous class of natural polyphenols with more than 6000 different compounds identified so far, belonging to anthocyanidins (more commonly present in form of anthocyanins, their glycoside derivatives), flavones and flavonols (and their alycosides), flavanones, dihydroflavonols such as Dyhydroquercetin (taxifolin), flavan-3-ols, flavan-3,4-diols (leucoanthocyanidins) and to polymeric proanthocyanidins. Flavonoids are especially common in leaves, flowering tissues, and woody pails such as stems, barks and roots. They are important for normal growth, development and defense of plants against infection and injury.

Dihydroquercetin (taxifolin) is known as primary antioxidant and act as free radical acceptor and chain breaker. Dihydroquercetin. (taxifoliti) is known to chelate metal ions at the 3-hydroxy-4-keto group. An o-quinol group at the B-ring can also demonstrate metal chelatine activity. It has been established that the position and degree of hydroxylation are of primary importance in determining of antioxidant capacity of flavonoids. All flavonoids with 3′,4′-dihydroxy configuration possess antioxidant activity [40].Hydroxylation of the B-ring is the major consideration for antioxidant. Other important features include a carbonyl group at position 4 and a free hydroxyl group at position 3 and/or 5 [40].

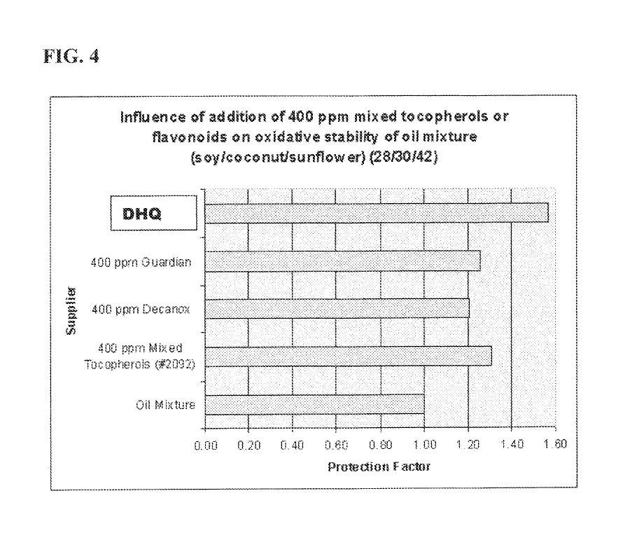

FIG. 4 shows an example of antioxidant expectations check-in according Rancimat trials with Dihydroquercetin (taxifolin)—DHQ. The activity of an antioxidant can be estimated by quantitatively determining primary or secondary products of auto-oxidation of lipids or by monitoring other variables. Generally, the delay in hydroperoxide formation or production of secondary products of auto-oxidation by chemical or sensory methods can be used. These procedures can be applied to intact foods, their extracts or to model systems. Studies on foods can be performed under normal storage conditions or under accelerated oxidation such as active oxygen method (AOM). Schaal oven test, oxygen uptake/absorption, and oxygen bomb calorimetry, or by using a fully automated oxidative stability instrument (OSI), a Rancimat apparatus, or an oxidograph, among others.

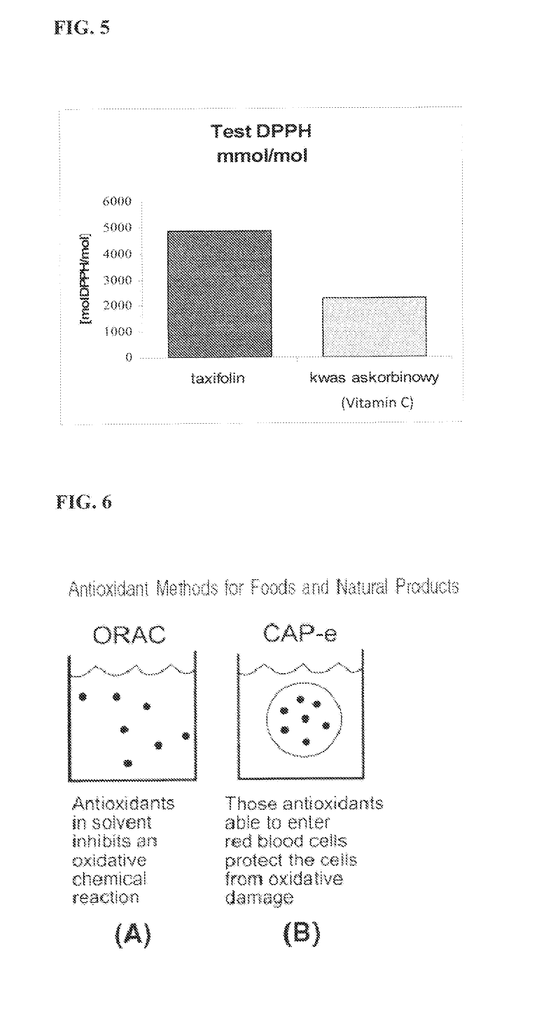

It is also possible to use a luminescense apparatus, also known as PHOTOCREM (Analytik Jena, Delaware, Ohio), which measures antioxidant activity of hydrophilic and lipophilic compounds (Amarowicz el al., 2003). ORAC (oxygen radical absorbance capacity) and TEAC (Trolox equivalent antioxidant capacity) tests have also been used in the recent literature; artificial radicals such as DPPH. (2,2-diphenyl-1-picrylhydrazyl) radical has been employed. FIG. 5 shows an example of DPPH test conducted on Dihydroquercetin (Taxifolin) to compare its antioxidant capacity to that of Vitamin C.

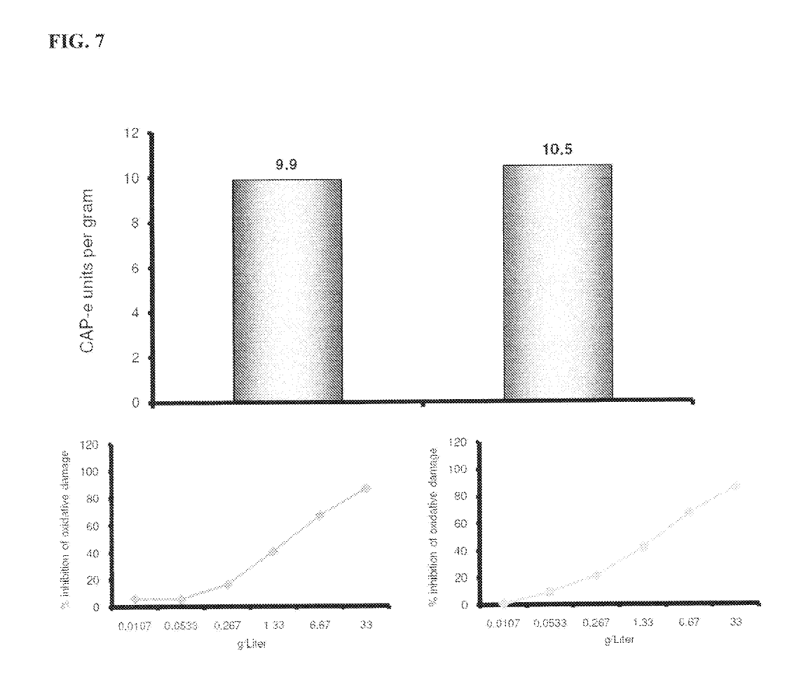

FIGS. 6 and 7 illustrate ORAC and CAP-e antioxidant tests conducted on Dihydroquercetin (taxifolin). The ORAC test measures the scavenging capacity at 37° C. of peroxyl radical induced by 2,2 -azobis-(2-amidinopropane) dihydrochloride (AAPH) using fluorescence at a wavelength of 565 nm with excitation at 540 nm. The results are calculated and expressed as milimoles of Trolox equivalents per gram. This test is widely used for evaluation and comparison of the antioxidant capacity in natural products and extracts and has been successfully applied to bioavailability studies, showing increased antioxidant capacity in serum in test subjects after consumption of antioxidant-rich foods.

Two different but synergistic testing principles are shown in FIG. 6: (A) The oxygen radical absorbance capacity (ORAC) assay is a chemical test, in which interference with specific chemical reactions are measured; (B) The cell-based antioxidant protection in erythrocytes (CAP-e) assay reflects whether antioxidants can enter into and protect live cells from oxidative damage. Dihydroquercetin (taxifolin) has the ORAC_{hydrophilic} assay over 15,000 μmol TE/g.

The following protocol was used for the tests illustrated in FIGS. 6 and 7:

For each test product, 0.4 g was mixed with 4 mL 0.9% saline at physiological pH. Products were mixed by inversion and then vortexed. Solids were removed by centrifugation at 2400 rpm for 10 minutes. The supernatant of the products was removed and then filtered for use in the CAP-e assay. Red blood cells were treated in duplicate with serial dilutions of the test products. Negative controls (untreated red blood cells) and positive controls (red blood cells treated with oxidizing agent) were performed in hexaplicate. The antioxidants not able to enter the cells were removed by centrifugation and aspiration of supernatant above the cell pellet. The cells were exposed to oxidative damage by addition of the peroxyl free-radical generator AAPH. Using the indicator dye DCF-DA, which becomes fluorescent as a result of oxidative damage, the degree of antioxidant damage was recorded by measuring the fluorescence intensity of each test sample. The inhibition of oxidative damage was calculated as the reduced fluorescence intensity of product-treated cells, compared to cells treated only with the oxidizing agent. The CAP-e value reflects the IC50 dose of the test product, i.e. the dose that provided 50% inhibition of oxidative damage. This is then compared to the IC50 dose of the known antioxidant Gallic Acid.

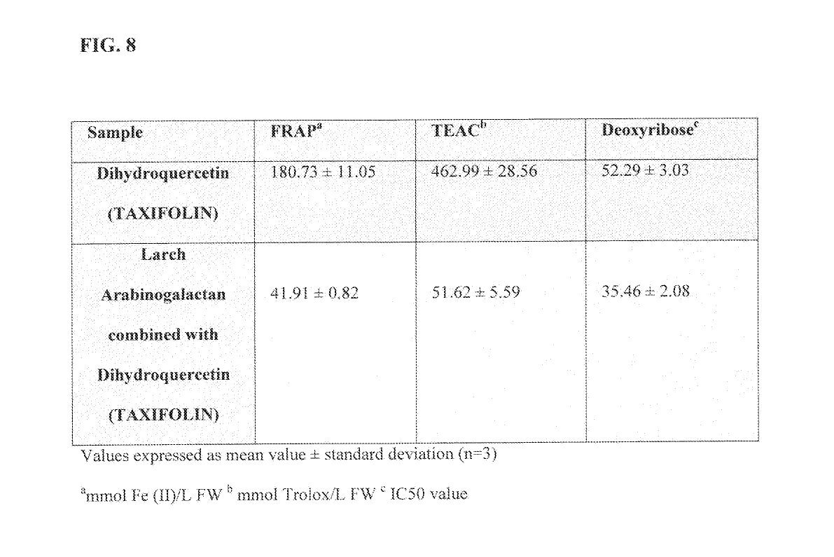

FIG. 8 depicts the results obtained in vitro and presented in the following order: the antioxidant capacities as determined by the FRAP, TEAC, and deoxyribose assays. All the samples investigated were found to exhibit anti-oxidative properties.

The FRAP assay takes advantage of electron-transfer reactions. Herein, a ferric salt, Fe(III)(TPTZ)₂Cl₃ (TPTZ=2,4,6-tripyridyl-s-triazine), is used as an oxidant. The reaction detects species with redox potentials<0.7 V [the redox potential of Fe(III)(TPTZ)₂], so FRAP is a reasonable screen for the ability to maintain redox status in cells or tissues. Reducing power appears to be related to the degree of hydroxylation and extent of conjugation in flavonoids. However, FRAP actually measures only the reducing capability based on ferric iron, which is not relevant to antioxidant activity mechanistically and physiologically.

The TEAC assay is based on the formation of fenylmyoglobin radical (from reaction of metmyoglobin with H₂O₂), which may then react with ABTS [2,2′-azinobis(3-ethylbenzothiazoline-6)-sulfonic acid] to produce the ABTS*⁺ radical. ABTS*⁺ is intensively colored, and AC is measured as the ability of the test species to decrease the color by reacting directly with the ABTS*⁺ radical. Results of test species are expressed relative to Trolox.

Deoxyribose assays: Hydroxyl radicals, generated by reaction of an iron-EDTA complex with H₂O₂ in the presence of ascorbic acid, attack deoxyribose to form products that, upon heating with thiobarbituric acid at low pH, yield a pink chromogen. Added hydroxyl radical “scavengers” compete with deoxyribose for the hydroxyl radicals produced and diminish chromogen formation. A rate constant for reaction of the scavenger with hydroxyl radical can be deduced from the inhibition of color formation. For a wide range of compounds, rate constants obtained in this way are similar to those determined by pulse radiolysis. It is suggested that the deoxyribose assay is a simple and cheap alternative to pulse radiolysis for determination of rate constants for reaction of most biological molecules with hydroxyl radicals.

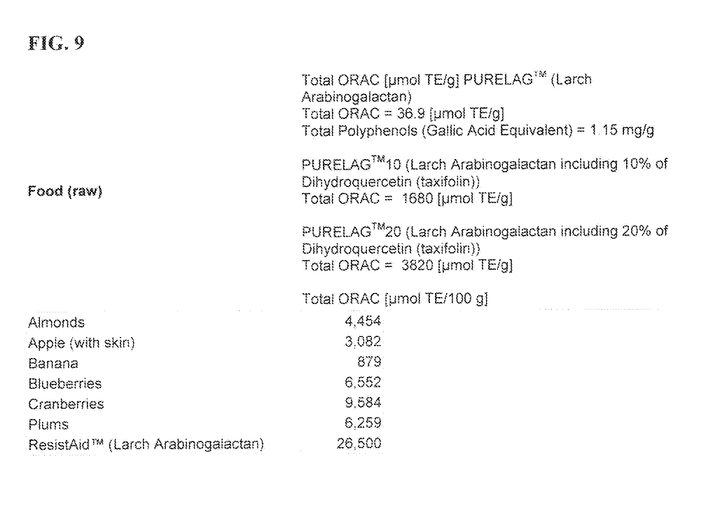

ORAC values of a variety of foods are shown in FIG. 9.

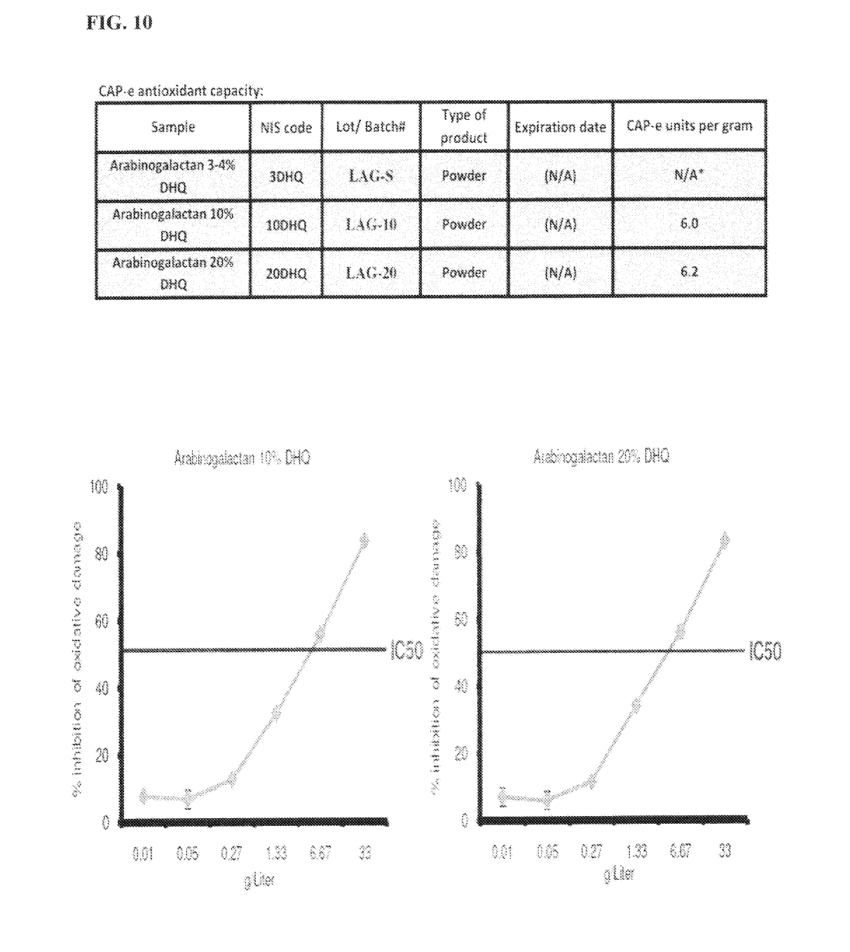

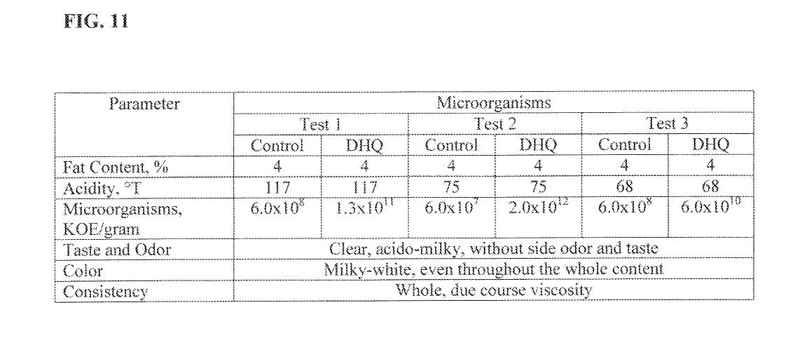

FIG. 10 depicts cell-based antioxidant protection (CAP-e) peroxyl of Arabinogalactan in combination with Dihydroquercetin (taxifolin). The following protocol was used for the tests illustrated in FIG. 10:

For each test product, 0.3 g was mixed with 3 mL 0.9% saline at physiological pH. Test products were mixed by inversion and then vortexed. After 15 minutes, solids were removed by centrifugation at 2400 rpm for 10 minutes. The supernatant of the product was removed and then filtered for use in the CAP-e assay. Red blood cells were treated in duplicate with serial dilutions of the test products. Samples of untreated red blood cells (negative controls) and samples of red blood cells treated with oxidizing agent but not with an antioxidant-containing test products (positive controls) were prepared in hexaplicate. The antioxidants not able to enter the cells were removed by centrifugation and aspiration of supernatant above the cell pellet. The cells were exposed to oxidative damage by addition of the peroxyl free-radical generator AAPH. Using the indicator dye DCF-DA, which becomes fluorescent as a result of oxidative damage, the degree of antioxidant damage was recorded by measuring the fluorescence intensity of each test sample. The inhibition of oxidative damage was calculated as the reduced fluorescence intensity of product-treated cells, compared to cells treated only with the oxidizing agent. The CAP-e value reflects the IC50 close of the test product, i.e. the dose that provided 50% inhibition of oxidative damage. This is then compared to the IC50 dose of the known antioxidant Gallic Acid.

FIG. 11 depicts positive bactericide effects of Dihydroquercetin (taxifolin) in yogurts.

As illustrated above, Dihydroquercetin (taxifolin) possess superior antioxidant activity to suppress affects of free radicals [53-59]. As used herein, Dihydroquercetin (taxifolin) is the flavonoid compound having molecule structure is based on C6-C3-C6 skeleton including of two aromatic rings joined by a three carbon link with the absence of the C2-C3 double bond and have two chiral carbon atoms in position 2 and 3 [FIG. 3]. The A ring of the flavonoid structure being acetate derived (3×C2) and the C and B rings originating from cinnamic acid derivatives (phenylpropanoid pathway). Consequently, the B-ring can be either in the (2S)- or (2R)-configuration. The C-3 atom of dihydroflavonol Dihydroquercetin (taxifolin) bears both a hydrogen atom and a hydroxyl group, and is therefore an additional center of asymmetry [44]. Thus, four stereoisomers are possible for each dihydroflavonol structure, (2R,3R), (2R,3S), (2S,3R), and (2S,3S). All four configurations have been found in naturally occurring dihydroflavonols, but the (2R,3R)-configuration is by far the most common. Conifer wood species, especially those from the family of Pinaceae are considered rich sources of flavonoid Dihydroquercetin (taxifolin) [45-52]. Dihydroquercetin (taxifolin), a white crystalline pentahydroxy-flavanone, occurring in large quantities in Douglas fir and Jeffrey pine barks, was found to be an effective antioxidant for lard, cottonseed oil, and butter oil [60, 61]. It has been further proved spectrophotometrically that Dihydroquercetin (taxifolin) could be used as the chelating agent [35].

Statistical analysis of the data showed that Dihydroquercetin (taxifolin) produced significant improvement of the flavor scores of powders packed in nitrogen containing 0.1 or 1.0% oxygen [62]. The addition of the dietary antioxidant Dihydroquercetin (taxifolin) to milks, produced during the dry-lot regime, inhibited the development of spontaneous oxidation [63-65]. The positive effects of different concentrations of Dihydroquercetin (taxifolin) in low fat yogurt on microorganism viability of Lactobacillus delbrueckii ssp. bulgaricus and Streptococcus thermophilus throughout the shelf life of the yogurt were evaluated along with macronutrient profile, folate content, and some physical characteristics [66,67]. Application of Dihydroquercetin (taxifolin) at minimal concentration 0.001% inhibited oxidation of the lipid fraction of minced meat with peroxide values in cooled samples produced according to a traditional recipe was lower by 57.1 and 58.60%, respectively, at day 7 of storage[68].The obtained results suggest that with the increase of DHQ added to the sausage meat, the stability to oxidation spoilage is increased [69].The investigations determined the adequate dosage of Dihydroquercetin (taxifolin) in applications for the technological receipts of meat products, which are considered more oxidative damaged—swine raw fat and poultry meat after mechanical rolling (fat content 16-18%). Such Dihydroquercetin (taxifolin) dosages were defined as 0.006% and 0.04% to fat content consequently of the products [70].Supported by Russian Institute of Dairy Industry had been elaborated technical conditions [9222-015-02068640-06] for the production of unpasteurized cottage cheese with Dihydroquercetin (taxifolin) and technical conditions [9222-011-02068640-06] for application for the production of sour cream pastes with Dihydroquercetin (taxifolin), wherein sour cream confirmed shelf-life 40 days and cottage cheese and yogurts 60 days at 0-20C. Further investigations supported by Russian Dairy Institute for the production of RTE/RTE with Dihydroquercetin (taxifolin) determined latter effects in dried mare milk with fat content of 15%, 20%, 25%- dry powder milk, in dry vegetable-milk products by procuring extension life of the products up to 1.5-2 times more. Investigations supported by Russian Institute of Storage and Preservation resulted to technical conditions for application for the production of ice-cream with edible oils and Dihydroquercetin (Taxifolin) procuring extension the shelf-life of the product up to 1.5-2 times more. It was established that superficial treatment with 0.1% aqueous Dihydroquercetin (taxifolin) solution effectively preserved sensory evaluated color and taste of salmon allowing 4 days extending of the product shelf life [71].

It have been demonstrated in numerous studies in vitro and ex vivo that Dihydroquercetin (taxifolin) inhibits lipid peroxidation, a process that often leads to atherosclerosis [72-74]. In an animal study, Dihydroquercetin (taxifolin) inhibited the peroxidation of serum and liver lipids following exposure to toxic ionizing radiation [75]. Dihydroquercetin (taxifolin)'s inhibitory effects on lipid peroxidation are enhanced by both vitamin C and vitamin E [76]. By inhibiting the oxidation of harmful low-density lipoprotein (LDL), Dihydroquercetin (taxifolin) may help prevent atherosclerosis [77].

### EXAMPLE 1

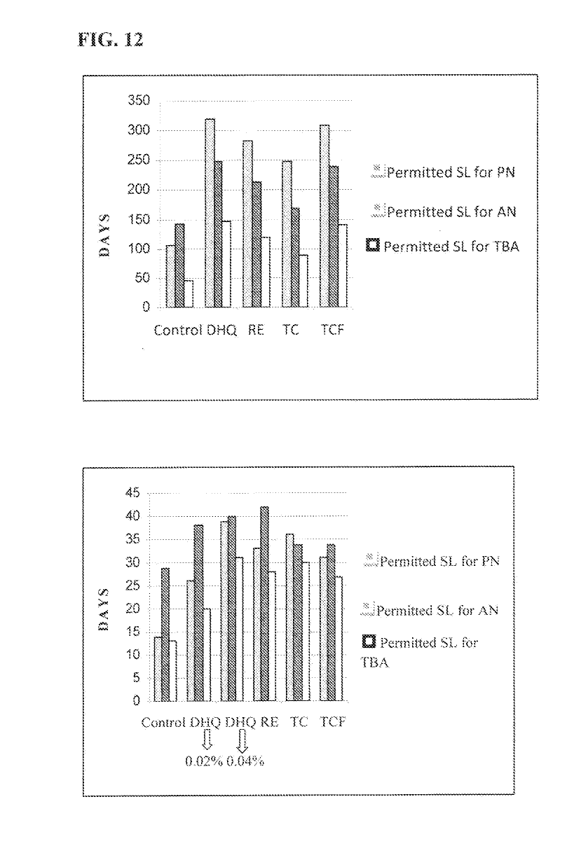

The example is illustrated in FIG. 12, in which FIG. 12(a) shows the forecasted shelf life (SL) of swine raw fat, and FIG. 12(b) shows the forecasted SL of poultry meat after rolling. The investigations were carried out in order to determine the adequate dosage of Dihydroquercetin (taxifolin)—DHQ in applications for the technological receipts of meat products, which are considered more oxidative damaged—swine raw fat and poultry meat after mechanical rolling (fat content 16-18%). Such DHQ dosages were defined as 0.006% and 0.04% to fat content consequently of the products. The antioxidant impact of DHQ dosages has been classified in accordance with the estimation of amendment of peroxide (PN), acid (AN) and thiobarbituryl (TRA) numbers.

For comparison the following dietary antioxidants were also used: 0.12% rosmarine extract (RE), 0.05% tea catechins (TC), 0.08% tocoferols (TCF) to the fat content of the products.

Studies indicate that Dihydroquercetin (taxifolin) is highly sate and efficacious. In fact, research suggests that dihydroquercetin is even safer than its nutritional cousin, quercetin [78,79]. No toxic effects were observed in rats that were treated with high levels of Dihydroquercetin (taxifolin) for long periods of time [80-87].

Preferred dietary antioxidant Dihydroquercetin (taxifolin) is extracted from plant materials from the Larix genus. For example, Dihydroquercetin (taxifolin) is one preferred dietary antioxidant because it is found in reasonable commercial yield in the Larix dahurica (Larix gmelinii), Larix sibirica, Larix sukaczewii species, which also contain arabinogalactan, a preferred polysaccharide.

As used herein, an Arabinogalactan is defined as the class of long, densely branched low and high-molecular polysaccharides with molecular weight range 3,000-120,000. Arabinogalactan consist of a main chain of b-D-(1fi3)-galactopyranose units (b-D-(1fi3)-Galp) where most of the main-chain units carry a side chain on C-6 [fi3,6)-Galp-(1fi]. Almost half of these side chains are b-D-(1fi6)-Galp dimers, and about a quarter are single Galp units. The rest contain three or more units. Arabinose is present both in the pyranose (Arap) and furanose (Araf) forms, attached to the side chains as arabinobiosyl groups [b-L-Arap-(1fi3)-LAraf-(1fi] or as terminal a-L-Araf e.g. a single L-arabinofuranose unit or 3-O-(β-L-arabinopyranosyl)-α-L-arabinofuranosyl units [88-91]. As used herein, “Arabinogalactan” includes purified as well as impure extracts of larch wood and other sources of arabinogalactan.

In food, Arabinogalactan neutral in taste, odor and color. It is used as an emulsifier, stabilizer, binder or bonding agent in essential oils, humectants, non-nutritive sweetener, flavor base, processing aid stabilizer [92]. It enhances the shelf-life of many types of foods. It retains moisture, and enhances mouth feel and texture [93]. Texture is improved in baked foods by reducing the stickiness of the dough and improving the external symmetry and internal grain scores [94]. In confectionary foods, arabinogalactan lowers water activity and aids in flavor and water retention. It has also been used to increase the stability of oils (by mixing or co-spray drying) that are often sensitive to degradation. Arabinogalactan is used in browning compositions for uncooked foods, in seasoning powders and spreads to improve flow or reduce hygroscopicity, or in starch containing foods to inhibit swelling. Being a highly soluble fiber with a very low viscosity, arabinogalactan leaves no negative impact on mouth feel. It is used for extension of the shelf-life of pasteurized milk up to 30 days being added at dosage of 0.1% of the product weight. Ingredient is also used as preservative to extend the shelf-life of the fresh egg yolk up to 30 days at the same dosage. It can be exposed to high heats and can withstand the rigors of an extrusion process. Arabinogalactan is highly water-soluble, readily disperses in a hot or cold beverage within 30 seconds (being in agglomerated form) and remains clear in solution and does not cause turbidity or precipitate out of solution. Arabinogalactan may be added to a beverage up to 60% of the daily reference value (DRV) for fiber without increasing its viscosity. The fiber will not hydrolyze at a low pH. Arabinogalactan is non-reactive making it ideal for beverage mixes, refrigerated or shelf-stable ready to drink beverages. It is heat stable up to 121° C. and can be heat pasteurized. Arabinogalactan is also easily incorporated into sports bars and meal replacements. It adds slight water binding activity, which is useful in keeping the bars moist over time. The neutral sensory profile and low gas forming potential compared to other dietary fibers, means the high amounts can be added to these nutritional bars. The present invention will be further understood by reference to the following non-limiting examples.

### EXAMPLE 2

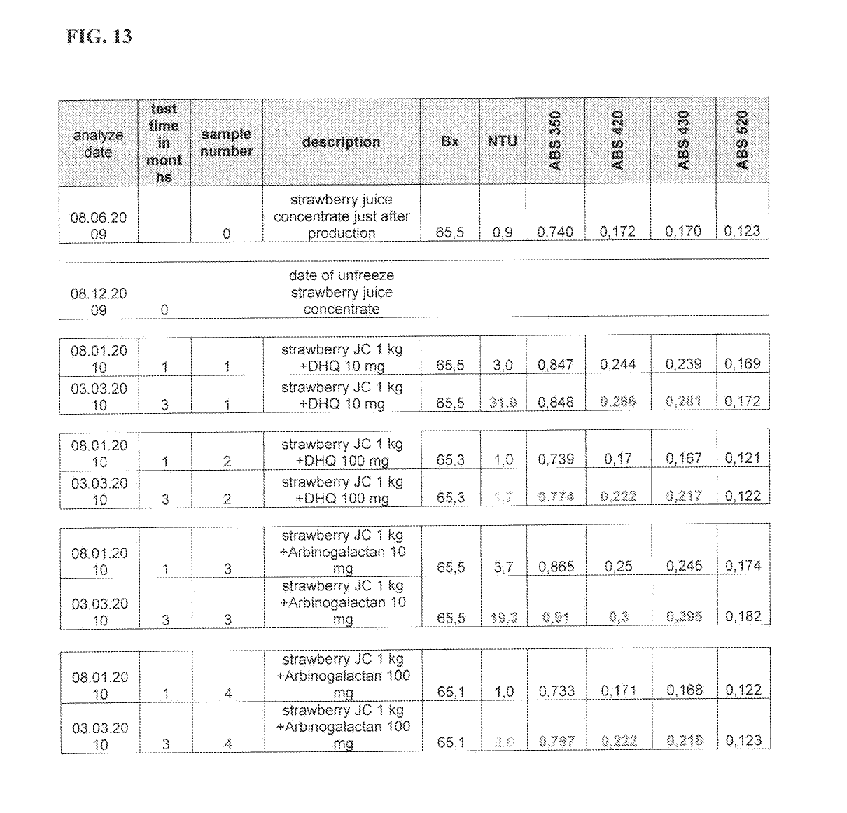

This Example is illustrated in FIG. 13 and details application of Dihydroquercetin (taxifolin) (“DHQ”) and Larch Arabinogalactan (“LAG”) in juice concentrates, i.e., the strawberry juice concentrate. “NTU” refers to Nephelometric Turbidity Units, Turbidity is the cloudiness or haziness of a fluid caused by individual particles (suspended solids) that are generally invisible to the naked eye, similarly to smoke in the air. “ABS” refers to light absorption in different wavelengths. Output parameters of strawberry juice concentrate are measured just after production, then standard JC is frozen to −18° C. and does not change parameters within 2 years of storage. On the date of unfreezing of the strawberry juice concentrate, a dosage of DHQ of 10 mg and 100 mg and of Arbinocialactan 10 mg and 100 mg is added, storage temp is set to 0-6° C. (standard temp for storing apple juice concentrate in tanks). Adding 10 mg of DHQ has no effect on the product. Juice concentrate loses color and NTU in a natural way.

Adding 100 mg of DHQ has a partial effect on the product. This dosage keeps turbidity (NTU) at a very good level, but only partially protects against loss of color.

Further, adding 10 mg of Arabinogalactan has no effect on the product. Juice concentrate loses color and NTU in a natural way.

Addition of 100 mg of Arabinogalactan has a partial effect on the product. This dosage keeps turbidity at a very good level, but only partially protects against loss of color.

The test has been made to check the possibility of lowering the cost of storing color fruit (strawberry) Juice Concentrate. Normally red color fruit JC (only strawberry, raspberry and red currant) is frozen to −18° C. and don't change parameters within 1 year. So we have additionally cost of freezing and storing in cool-house. But apple, cherry, black currant and others JC are storing in tanks were temp is 0-6° C. (smaller costs) so we test how behave strawberry JC with LAG or DHQ in this 0-6° C. This test was made in laboratory, one of juice concentrate producers. After 3 months of test, NTU is at a very good level but ABS for some clients specifications increased too much.

Intake of dietary fiber, particularly Arabinogalactan from conifer wood species, especially those from the family of Pinaceae, has been shown to be supportive in combating the detrimental effects caused by poor diet. Specifically Larch Arabinogalactan has been shown to increase short-chain fatty acids, decrease colonic ammonia levels, increase the numbers of beneficial bacteria in the colon, as well as improve the immune response. These favorable effects of Larch Arabinogalactan have a positive modulation of many of these too-common intestinal factors [132]. Arabinogalactan is also believed to act as a prebiotic; it stimulates the colonic growth of such bacteria as bifid bacteria and lactobacilli that confer certain health benefits. Ingestion of Arabinogalactan has a significant effect on enhancing beneficial gut micro-flora, specifically increasing anaerobes such as Lactobacillus. The non-absorbed dietary fiber of Arabinogalactan is easily fermented by the distal gut micro-flora, resulting in an elevated production of short-chain fatty acids, primarily butyrate, and, to a lesser extent, propionate.

As used herein Arabinogalactan from hardwoods, mainly from larch wood species, i.e. larch arabinogalactan can be defined as a fiber containing significant amounts of natural antioxidants, mainly Dihydroquercetin (taxifolin) associated naturally to the fiber matrix with the following specific characteristics: 1. Dietary fiber content, higher than 70% dry matter basis. 2. One gram of dietary fiber larch arabinogalactan should have a capacity to inhibit lipid oxidation equivalent to, at least, 1,000 umol TE/gram basing on ORAC value. 3. One gram of dietary fiber larch arabinogalactan should have a capacity of Cell-based Antioxidant Protection (CAP-e) to protect live cells from oxidative damage to, at least 6 CAP-e units per gram, where the CAP-e value is in Gallic Acid Equivalent (GAE) units. 4. The antioxidant capacity possess an intrinsic property, derived from natural constituents of the material (soluble in digestive fluids) not by added antioxidants or by previous chemical or enzymatic treatments.

Preferred dietary ingredients Arabinogalactan and Arabinogalactan in combination with antioxidant Dihydroquercetin (taxifolin) are extracted from plant materials from the Larix genus. For example, Arabinogalactan and Dihydroquercetin (taxifolin) are the preferred dietary ingredients because both were found in reasonable commercial yields in the Larix dahurica (Larix cmelinii), Larix sibirica, Larix sukaczewii species.

In a typical process for preparing wood extracts useful inthe present invention, wood from a tree of the genus Larix, for example, Larix dahurica (Larix gmelinii), Larix sibirica, Larix sukaczewii species, is chipped or pulverized. The wood is then extracted with appropriate solvent in accordance with the principle of solid-liquid extraction in vacuum system, is that when a solid material comes in contact with a solvent agent, the soluble in mixture components in the solid wood particles such as Dihydroquercetin (taxifolin), Arabinogalactan and Arabinogalactan in combination with flavonoid Dihydroquercetin (taxifolin) moves to the solvent agent. Thus, solvent extraction under vacuum of wood material results in the mass transfer of soluble active principles to the solvent agent, and this takes place in a concentration gradient. Since mass transfer of the active principles Dihydroquercetin (taxifolin), Arabinogalactan and Arabinogalactan in combination with flavonoid Dihydroquercetin (taxifolin) also depends on their solubility in the solvent agent, heating the solvent mixture can enhances the mass transfer.

The term Dihydroquercetin (taxifolin) as used herein refers to flavonoid Dihydroquercetin (taxifolin) obtainable from natural sources such as from products and by-products derived from coniferous wood or the wood is hardwood by extraction and/or purification. The purity of flavonoid Dihydroquercetin (taxifolin) can be determined by methods known to a person skilled in the art such as e.g. by HPLC, or LC-MS. Furthermore, the term Dihydroquercetin (taxifolin) also encompasses physiologically/nutraceutically/pharmaceutically acceptable salts and esters. One or several of the hydroxy groups of Dihydroquercetin (taxifolin) may also be etheri lied or esterified to form for example acetates.

Examples of references that deal with the extraction of Dihydroquercetin (taxifolin) from coniferous wood or the wood is hardwood by extraction and/or purification are WO Pat. No. 00/37479; WO Pat. No. 2010/095969 A1; U.S. Pat. No. 5,756,098; EP Pat. No. 86608; U.S. Pat No. 5,116,969 which disclose a methods of extraction and/or purification of Dihydroquercetin (taxifolin).

The term Arabinogalactan as used herein refers to polysaccharide Arabinogalactan obtainable from natural sources such as from products and by-products derived from coniferous wood or the wood is hardwood by extraction and/or purification. The purity of polysaccharide Arabinogalactan can be determined by methods known to a person skilled in the art such as e.g. by HPLC, or LC-MS or Analyzer or size exclusion chromatography (SEC). Furthermore, the term. Arabinogalactan also encompasses physiological ly/nutraceutically/pharmaceutically acceptable salts and esters.

Examples of references that deal with the extraction of polysaccharide Arabinogalactan from coniferous wood or the wood is hardwood are U.S. Pat. No. 5,756,098; EP Pat. No. 86608; U.S. Pat. No. 4,950,751; U.S. Pat. No. 1,339,489; U.S. Pat. No. 1,861,933; U.S. Pat. No. 2,832,765; U.S. Pat.No. 3,337,526; U.S. Pat. No. 1,358,129; U.S. Pat. No. 2,073,616; U.S. Pat. No. 3,325,473; U.S. Pat No. 5,116,969; U.S. Pat. No. 1,913,607; U.S. Pat. No. 2,008,892 which disclose a methods of extraction and/or purification of polysaccharide Arabinogalactan.

The term Arabinoualactan in combination with Dihydroquercetin (taxifolin) as used herein refers to substance of polysaccharide Arabinogalactan in combination with flavonoid Dihydroquercetin (taxifolin) and obtainable from natural sources such as from products and by-products derived from coniferous wood or the wood is hardwood by extraction and/or purification i.e. arabinogalactan can be defined as a fiber containing significant amounts of natural antioxidants, mainly Dihydroquercetin (taxifolin) associated naturally to the polysaccharide or fiber matrix with the following specific characteristics: 1. Dietary fiber content, higher than 70% dry matter basis. 2. One gram of dietary fiber larch arabinoaalactan should have a capacity to inhibit lipid oxidation equivalent to, at least. 1,000 umol TE/gram basing on ORAC value. 3. One gram of dietary fiber larch arabinogalactan should have a capacity of Cell-based Antioxidant Protection (CAP-e) to protect live cells from oxidative damage to, at least 6 CAP-e units per gram, where the CAP-e value is in Gallic Acid Equivalent (GAE) units. 4. The antioxidant capacity possess an intrinsic property, derived from natural constituents of the material (soluble in digestive fluids) not by added. antioxidants or by previous chemical or enzymatic treatments. The purity of Arabinogalactan in combination with Dihydroquercetin (taxifolin) can be determined by methods known to a person skilled in the art such as e.g. by HPLC, or LC-MS or analyzer or size exclusion chromatography (SEC). Furthermore, the term Arabinogalactan in combination with Dihydroquercetin (taxifolin) also encompasses physiologically/nutraceutically/pharmaceutically acceptable salts and esters.

Examples of references that deal with the extraction of Arabinogalactan in combination with Dihydroquercetin (taxifolin) from coniferous wood or the wood is hardwood are U.S. Pat. No. 5,756,098, EP Pat. No. 86608 which disclose a methods of extraction and/or purification of polysaccharide Arabinogalactan in combination with Dihydroquercetin (taxifolin).

Food products or food are treated with compositions according to the present invention to achieve the following criteria: 1. to demonstrate a reasonable technological need; 2. to present no hazard to the health of the consumer at the level of use proposed, so far as can judged on the scientific evidence available; and 3. to do not mislead the consumer.

The use of Dihydroquercetin (taxifolin), Arabinogalactan and Arabinogalactan in combination with Dihydroquercetin (taxifolin) in food products or food is considered following the evidence that the proposed use of the above ingredients have demonstrable benefit to the consumer. The use of Dihydroquercetin (taxifolin), Arabinogalactan and Arabinogalactan in combination with Dihydroquercetin (taxifolin) serve one or more of the purposes set out below: 1. to preserve the nutritional quality of the food, wherein an intentional reduction in the nutritional quality of a food is justified only where the food does not constitute a significant item in a normal diet or where the ingredients are necessary for the production of foods for groups of consumers having special dietary needs; 2. to provide mentioned ingredients or constituents of foods manufactured for groups of consumers having special dietary needs; 3. to enhance the keeping quality or stability of a food Or to improve its organoleptic properties, without change the nature, substance or quality of the food, including purposes to ingredients be used as antioxidants to prolong the shelf-life of foodstuffs by protecting them against deterioration caused by oxidation and preservatives to prolong the shelf-life of foodstuffs by protecting them against deterioration caused by microorganisms; 4. to provide aids in manufacture, processing, preparation, treatment, packing, transport or storage of food.

In accordance with the present invention, the food or food product can be any substance consumed to provide nutritional support for the body. It is usually of plant or animal origin, and contains essential nutrients, such as carbohydrates, fats, proteins, vitamins, or minerals. The substance is ingested by an organism and assimilated by the organism's cells in an effort to produce energy, maintain life, or stimulate growth.

The dietary ingredients in accordance with the present invention may be in the form of a dry powder that can be sprinkled on or mixed in with the food product or food. The dietary ingredients in the form of a dry powder may include an additive such as any composition/formulation added to food/feed during its manufacture or its preparation for consumption.

Patents, patent applications, and documents disclosed herein are hereby incorporated by reference as if individually incorporated. it is to be understood that the above description is intended to be illustrative, and not restrictive. Various modifications and alterations of this invention will become apparent to those skilled in the art from the foregoing description without departing from the scope and the spirit of this invention, and it should be understood that this invention is not to be unduly limited to the illustrative embodiments set forth herein.

What is claimed is:

1. A method of using a dietary ingredient, the method comprising the steps of
combining an effective amount of a dietary ingredient selected from the group consisting of Dihydroquercetin (taxifolin), Arabinogalactan and Arabinogalactan in combination with Dihydroquercetin (taxifolin) with a food such that the dietary ingredient preserves nutritional quality of the food, enhances a shelf life or stability of the food and improves organoleptic properties of the food without changing a nature, substance or quality of the food; and
providing the combination of the dietary ingredient and the food to a eroup of consumers having special dietary needs,
wherein the dietary ingredient is used as an antioxidant to prolong the shelf-life of the food by protecting it against deterioration caused by oxidation and preservatives, to prolong the shelf-life of the food by protecting it against deterioration caused by microorganisms, and to aid in manufacturing, processing, preparation, treatment, packing, transporting or storing of the food.

2. The method of claim 1 wherein an amount of the Arabinogalactan or the Arabinogalactan in combination with Dihydroquercetin (taxifolin) present in the food is in a range from about 0.5% solids to about 30% solids.

3. The method of claim 1 wherein an amount of the Dihydroquercetin (taxifolin) present in the food is in a ranize from about 0.005% solids to about 5% solids.

4. The method of claim 1 wherein the dietary ingredient is supplied to the food as a powder.

5. The method of claim 1 wherein the dietary ingredient is an aqueous solution of a wood extract.

6. The method of claim 1 wherein the step of combining the dietary ingredient with the food comprises mixing the dietary ingredient with the food so that the dietary ingredient is retained in the food in an effective amount.

7. The method of claim 1 wherein the step of combining the dietary ingredient with the food comprises mixing the dietary ingredient with the food.

8. The method of claim 1 wherein the step of combining the dietary ingredient with the food comprises a technique selected from the group consisting of sprayint, dipping, rinsina, brushing, and a combination thereof.

9. The method of claim 7 wherein the food is any substance consumed to provide nutritional support for a body, ingested by an organism and assimilated by an organism's cells in order to produce energy, maintain life, or stimulate growth.
